(19) United States
(12) Patent Application Publication
(10) Pub. No.: US 2008/0295076 A1
(43) Pub. Date: Nov. 27, 2008

(54) Graphical user interface testing

(75) Inventors: Stephen Michael McKain, Kirkland, WA (US); Ulziidelger Lobo, Redmond, WA (US); Justin Wallace Saunders, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/805,295

(22) Filed: May 23, 2007

(51) Int. Cl. G06F 11/36; G06F 9/44

(52) U.S. Cl. 717/124; 714/32; 714/E11.207

(57) ABSTRACT

Graphical user interface testing is provided. User interface (UI) build data and text data are transformed into a testable data format, such as XML, by a UI parser. The transformed UI data may be stored to a backend server where stored procedures and functions may be utilized to analyze the UI data against build differencing procedures, command mapping procedures, comparison to previous or subsequent user interface builds, etc. Additional stored procedures may allow UI testers to query data, create test suites and record testing information for a given UI. A front end testing module may provide a testing user an interface to query the backend database for information on various UI components and to review results for tests conducted on UI data. The front end testing module may also provide an interface for allowing testers to generate and execute new tests for a given user interface.

### BACKGROUND OF THE INVENTION

Graphical user interfaces may contain hundreds or even thousands of content items, for example, functionality buttons and controls, icons, command bars, toolbars, menus, dialog boxes, and scores of configurable properties, including user interface component size, location, color, and the like. Testing user interface (UI) content is a daunting task for UI developers and testers. Often testing is done through a manual process where each possible combination of UI content for a given software application UI is manually reviewed for functional errors and aesthetic quality. In the past, it has been very difficult for testers to test and do quality reviews of UI content in non-manual ways, such as automated review of application code change lists, because data associated with instances of a given UI may be closely related to data associated with other instances of the given UI, and thus, a single code change directed to one instance of the UI may affect many other instances of the UI.

It is with respect to these and other considerations that the present invention has been made.

### SUMMARY OF THE INVENTION

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing improved graphical user interface testing methods and systems. According to an embodiment of the invention, user interface (UI) build data and data associated with all UI content for a given user interface are passed to a UI parser where text and data files associated with the given user interface are transformed into a data format, for example, the Extensible Markup Language (XML) format that makes testing of UI data more efficient. For example, XML data may be generated for properties and components of the associated user interface, such as UI paths, accelerator key paths, label paths, tool tips, commands, UI component state information, icon file data, UI component location, UI component properties, and the like.

The transformed UI data may be stored to a backend server where stored procedures and functions may be used to analyze the UI component data against build differencing procedures, command mapping procedures, comparison to previous or subsequent user interface builds, etc. Additional stored procedures may allow UI testers to query data, create test suites and record testing information for a given UI.

A front end testing module may provide a testing user interface for allowing testers to query the backend database for information on various UI components and to review test results for tests conducted on UI data. The front end testing module may also provide an interface to the backend server for allowing testers to generate and execute new tests for a given user interface based on other testing results and/or based on additional modifications to the user interface.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a simplified block diagram of a system architecture for graphical user interface testing.

FIG. 2 is a simplified block diagram illustrating a transformation of user interface build data into a format suitable for testing.

FIG. 3 is a simplified block diagram illustrating the processing of user interface build data for storage and testing in a user interface test database.

FIG. 4 is a logical flow diagram illustrating a method for graphical user interface testing.

FIG. 5 is a simplified block diagram illustrating an example computing operating environment in which embodiments of the present invention may be practiced.

### DETAILED DESCRIPTION

As briefly described above, embodiments of the present invention are directed to providing graphical user interface testing methods and systems. The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

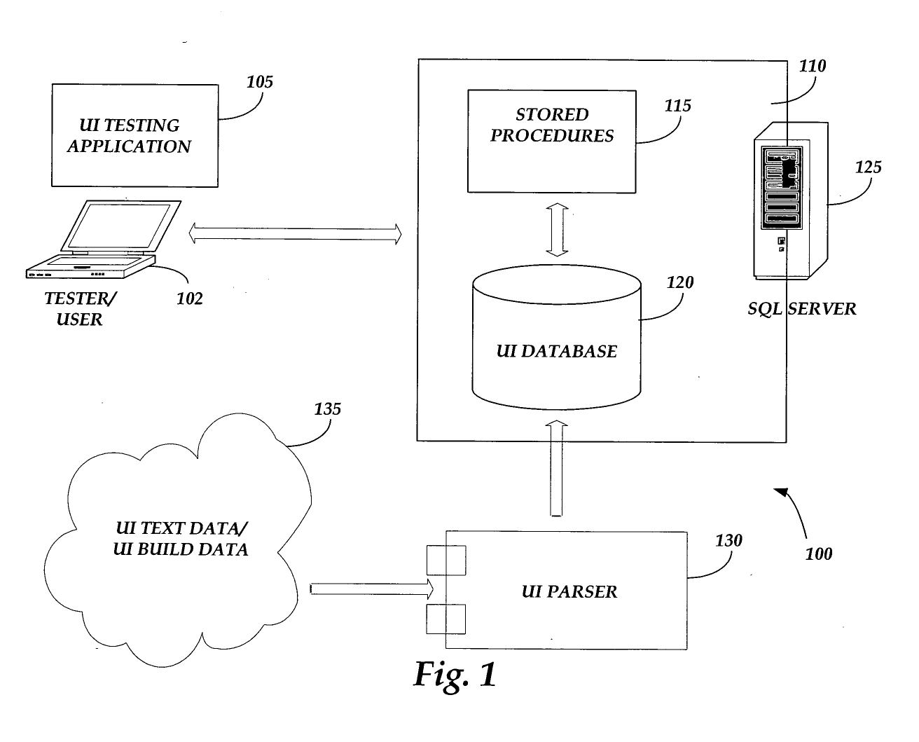

FIG. 1 is a simplified block diagram of one example architecture for a graphical user interface testing system 100. The UI data/UI build data 135 is illustrative of all data associated with UI components and UI construction that may be stored and analyzed by the system 100. The UI parser module 130 is a software module operative to parse the UI data/UI build data 135 and to produce Extensible Markup Language (XML) data for each UI data/UI build data item, including unique UI path identifiers, UI label paths, XML paths, accelerator key paths, command data, UI component state data, tooltip data, icon data, etc.

During a transformation process at the parser module 130, all UI text files may be converted to more readable XML-based files and may be stored a build target folder for later consumption by a primary parser within the parser module 130. Upon completion and release of build data for an associated UI to a local file share storage medium, a secondary parser within the UI parser module 135 may open each XML data file and may convert the UI build data and associated text file data into a test-consumable format. The parser module 135 is operative to pass the XML data for the UI text files and build data to a backend server 125 for further processing.

The backend server 125 and associated database 120 and stored procedures 115 process the data received from the parser module 130 with stored procedures 115 and Automated Integrated Services in a scheduled fashion. According to one embodiment, the server 125 may be in the form of a SQL Server manufactured by MICROSOFT CORPORATON. The server 125 may run indexing services, build differencing procedures, and command mapping procedures to compare older UI builds to newer UI builds. Some stored procedures may enable testers to query the UI data, create test suites, and record test suite and build differencing runs. These stored procedures also provide aggregate data for metrics and test status analysis.

The front end testing application 105 is operative to allow UI testers 102 to query a given UI build based on defined parameters, to review returned test results, to generate new test suites based on current controls in a software application owning the tested UI, to review changes in the UI build that impact particular UI controls of interest to a given UI tester, and to log all results for all testing for future analysis and review. According to one embodiment the front end testing application 105 may be in the form of a C#-based application.

Advantageously, with use of the graphical user interface testing system 100, a UI tester no longer is required to create and maintain granular lists of all the controls and related data in the user interfaces of a tested application. The testing system 100, illustrated in FIG. 1, parses that information out for the tester. The tester needs only to determine what query to run for obtaining a latest list of controls added to a test suite that meets the query expectations. This also enables the tester to get desired granularity of test cases without the added difficulty and time-consumption of test case and data maintenance. Thus, the tester may spend more time testing a software application and less time dealing with testing documentation.

This graphical user interface testing system 100 may be extensible to other UI issues, for example, auto generation of steps for help files, auto generation of specific test cases based on known UI types, control ownership tracking, bug tracking for particular UI controls, localization (translation and internationalization) comparisons to make sure controls are localized properly, locating and eliminating duplicate accelerator keys, and locating and reporting controls that break with UI design and implementation guidelines that could not be caught any other way (e.g., verification that no ellipses are on menu labels).

According to an embodiment, the testing system 100 also may be operative to link UI usage data with UI control data. Such data linkage allows testers to know how to prioritize their UI control testing as they can leverage UI control usage data percentages as the prioritization model.

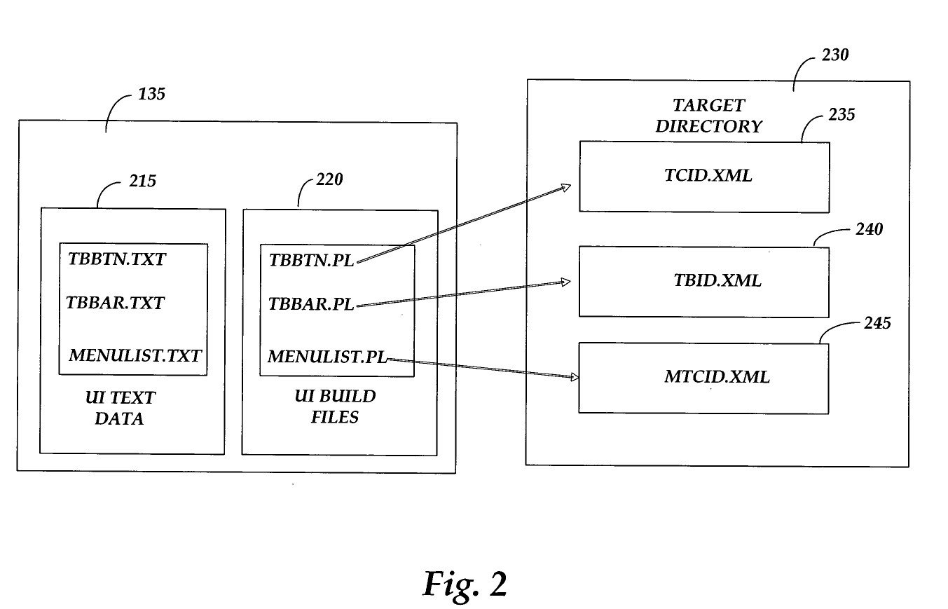

The simplified block diagram shown in FIG. 2 illustrates the process by which the UI parser 130 transforms data contained in UI build files and UI text files into a format that may be stored in a UI database 120 for subsequent searching, analysis and testing. Referring to FIG. 2, the UI text data/UI build data 135 is illustrative of all data associated with UI components and UI construction that may be stored and analyzed by the system 100. For example, the user interface text data 215 and the user interface build file 220 may contain all data associated with a graphical user interface that will be displayed by a word processing application for allowing the preparation of documents according to the functionality of the example word processing application.

The user interface text data 215 includes a number of example text files including a tool bar button text file identified as “TBBTN.TXT,” a toolbar bar text file identified as “TBBAR.TXT,” and a menu list text file identified as “MENULIST.TXT.” Each of these text files may be representative of text strings that will be provided on associated functionality controls in the example user interface. For example, the toolbar button text file may be representative of a text string displayed on a toolbar, for example, “file,” “edit,” “tools,” etc. Similarly, the menu list text file may be representative of text strings displayed in one or more menus, for example, a drop-down menu, for allowing a user to select associated functionality provided via the menu.

The user interface build files 220 may include files containing data associated with the construction and operation of associated user interface components. For example, the toolbar button build file designated as “TBBTN.PL” is illustrative of a PERL-based data transform utility for an associated UI build file that contains data associated with construction, rendering and display of an associated toolbar user interface component.

As should be appreciated, the text files and build files 215, 220 illustrated in FIG. 2 are for purposes of example only are not limiting of all the numerous types of data files and build files that may be associated with a given user interface and that may require transformation by the parser module 130 into XML formatted data, as described herein. For example, user interface text data and build files contained in the UI text data/UI build data 135 may include data in many different formats associated with labels, icons, accelerator keys, label paths, tooltips, command buttons, command bars, UI state information, icon file data, locations of user interface components, and the like. The data 135 may also include data on items that may or may not be visible to an end user, for example, friendly names associated with a given functionality button or control used by the UI developer. Indeed, according to embodiments of the present invention, any data associated with any feature, property, attribute, or construct of a given UI may be transformed by the parser module 130 into an associated XML formatting for storage in the UI database for subsequent testing, analysis and searching, as described herein.

As described above, the UI parser module 130 is operative to convert each of the UI text files 215 and the UI build files 220 for a given user interface into a format which subsequently may be easily and efficiently stored, searched, and acted on. According to one embodiment, the format into which the parser 130 transforms the user interface text data and user interface build data is the Extensible Markup Language (XML) format. As is well known to those skilled in the art, XML is comprised of a self-defining markup language with which each of the UI text data items 215 and each of the UI build file data items 220 may be tagged according to a defined XML tag which allows subsequent location and processing of individual data items to be highly efficient. An example of the XML transformation process is illustrated in FIG. 2. The UI text data 215 is transformed by the PERL-based scripts 220 from the .TXT files to corresponding .XML files. For example, the TBBTN.TXT file is transformed from the .TXT file into an XML-based toolbar command identification format “TCID.XML” 235 by the associated PERL script (TBBTN.PL), the TBBAR.TXT file likewise is transformed to tool bar identification format “TBID.XML” 240 by the associated PERL script (TBBAR.PL), the MENULIST.TXT file likewise is transformed to a menu toolbar command identification format “MTCID.XML” 245 by the associated PERL script (MENULIST.PL), and so on.

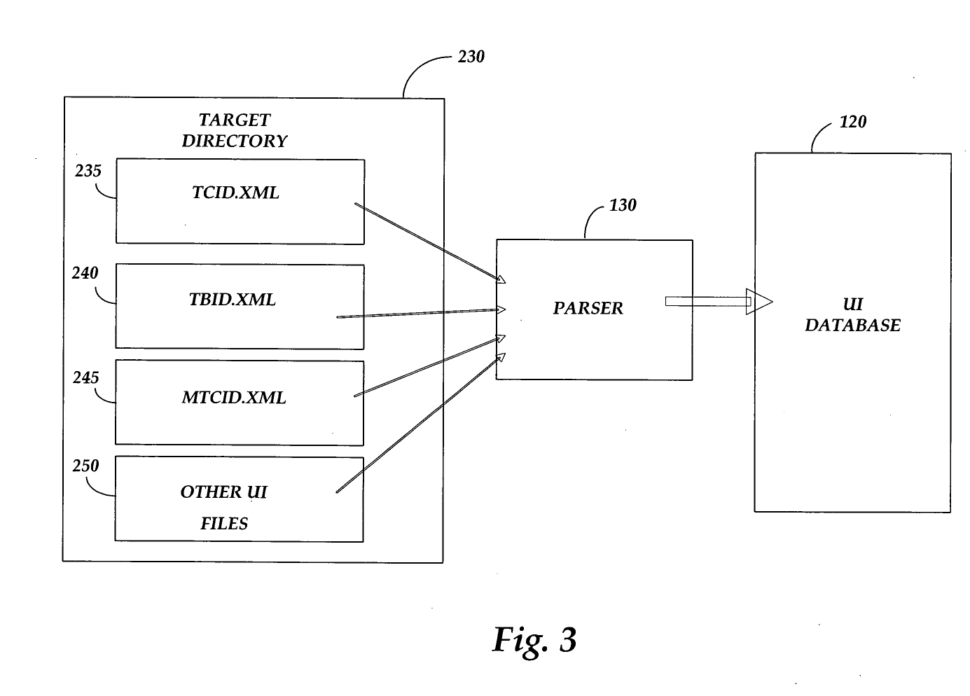

As illustrated in FIG. 3, after transforming each user interface text data item and user interface build file into an XML format, each particular UI text data item and each particular UI build file data item may be stored in the UI database 120 according to a defined XML markup tag. For example, a user interface text string “file” that may be displayed in many different places in a given user interface may be tagged according to a particular TCID.XML tag before being stored in a UI database. Subsequently, as will be described further below, a tester desiring to find all instances of the text string “file” found in a given user interface may utilize the parser 130 for parsing the stored XML files for all instances of the XML tag associated with the text string “file.” Thus, the tester may quickly and efficiently locate all instances of the desired text string occurring anywhere in the reviewed user interface without the need for manually locating each instance of the desired text string.

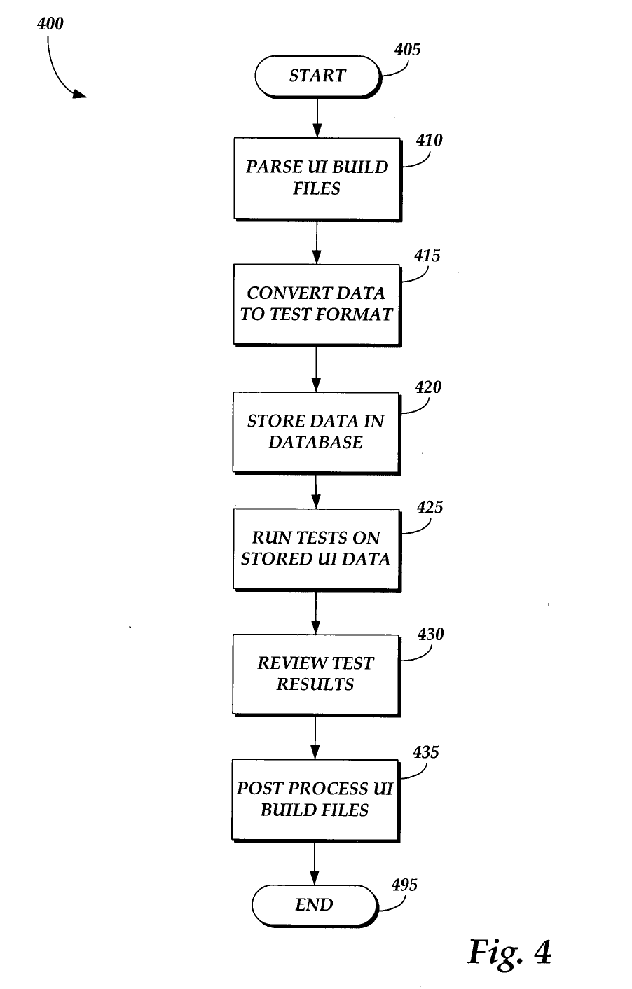

Having described a system architecture for embodiments of the present invention above with respect to FIGS. 1-3, is advantageous to further describe the invention in terms of an example operation of the graphical user interface testing system 100. FIG. 4 is a logical flow diagram illustrating a method for graphical user interface testing according to embodiments of the present invention. For purposes of description of FIG. 4, consider that a developer has completed a build of a new user interface for a word processing application and that an associated UI tester desires various testing and analysis on different components and properties of the new user interface.

Referring then to FIG. 4, the UI testing method 400 begins at start operation 405 and proceeds to operation 410 where all user interface text data and user interface build data according to formatting associated with each data type is retrieved from the data files 215, 220 for the user interface by the parser module 130 for conversion of each of the UI text data files and UI build files into a format that readily may be used for subsequent storage, analysis, searching and testing. At operation 415, the parser module 130 converts each user interface text data item 215 and each user interface build file 220 into an associated XML formatted file.

At operation 420, the XML-formatted text data items and build files are stored by the parser module 130 to the user interface database 120. As described above with reference to FIG. 1, the user interface database 120 in association with the SQL server 125 may be responsible for processing the data with stored procedures and integrated services 115 in a scheduled fashion. Indexing services may be run on the stored data, build differencing may be run on the stored data to compare the stored data for a given user interface build with a previous or subsequent user interface build. Other stored procedures 115 contained in the database 120 may allow the tester to query the data based on the XML formatting of the data to create test suites associated with the data and to provide data aggregation and metrics for testing analysis.

At operation 425, a tester utilizes the front end testing application 105 to run one or more tests, to conduct one or more searches, or to review one or more UI data items or UI build files as desired, as described by examples below. At operation 430, any tests performed on one or more data items stored in the database 120 may be reviewed by the tester via the front end user interface application 105. At operation 435, any post-processing required in response to the testing, searching, or analysis of one or more data items or build files associated with the user interface may be performed.

For an example of the above-described user interface testing method, consider that a program manager, developer or tester is concerned that a text string, for example, “edit” has been applied to various user interface buttons or controls or has been included in one or more user interface menus, and that the text string “edit” has been applied with a font scheme that is inappropriate for the user interface when it will be utilized in a different country where the utilized font scheme is not applicable to the language used by users therein. According to embodiments of the present invention, each user interface text item and/or user interface build file containing the text string “edit” will be converted to a corresponding XML-based data item and will be stored in the user interface database 120 during the data parsing process described above.

In order to find each instance of the text string “edit” according to embodiments of the present invention, the program manager, developer or tester may launch the UI testing application 105, illustrated in FIG. 1, and run a search on all XML-based UI data items and build file items stored for the subject user interface to find all instances of the text string “edit.” In response, a user interface provided by the UI testing application 105 may list information on each instance of the text string “edit” including the location of the text strings, font properties associated with the text strings, display properties associated with the text strings, executable files associated with the text strings, and the like. Thus, in a matter of minutes, or even seconds, the tester may locate each instance of the desired text string without having to manually review each possible instance of the user interface and its various components searching for the subject text string to determine its properties.

For another example, if a developer utilized a friendly name for a particular user interface control and cannot remember the location of the control, the developer may use the testing application 105 to quickly locate the friendly name in the user interface owing to the ability to parse the XML-formatted data stored in the user interface database 120 to locate the desired friendly name.

For another example, if it is determined that a particular drop-down menu on a present build of a given user interface does not deploy correctly, but it is known that a similar drop-down menu deployed correctly in a previous build of the subject user interface, a tester may run a test suite that parses the XML-formatted data in the user interface database 120 for UI build data on the drop-down menu for the current build to compare the current build data to UI build data for the corresponding drop-down menu in the previous build of the subject user interface. By comparing the XML-formatted build data for the two drop-down menus, the tester may quickly and efficiently determine the build differences between the two drop-down menu builds for determining problems with the new build and for making any necessary repairs to the new build so that the subject drop-down menu will deploy properly.

### Operating Environment

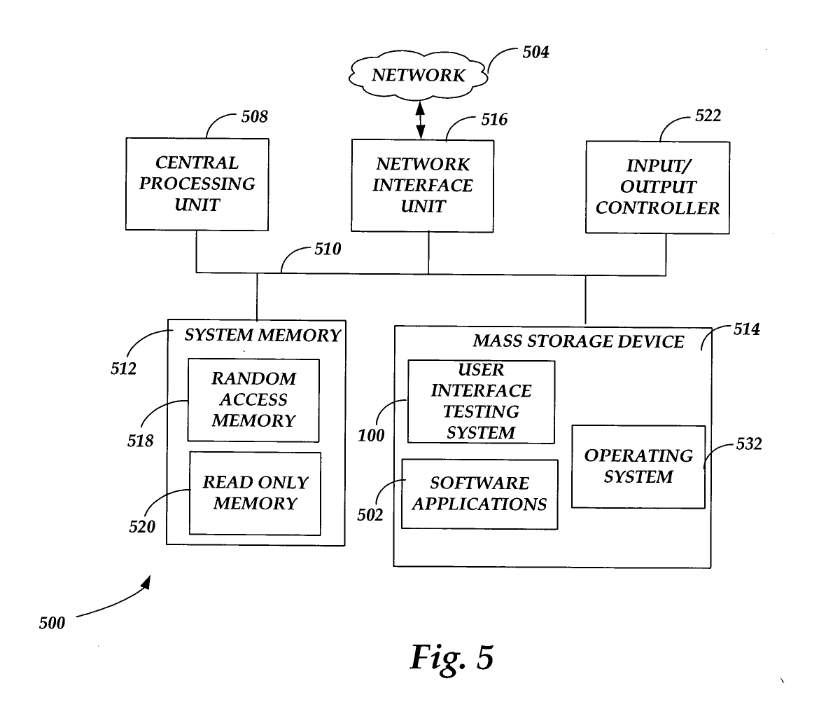

Referring now to FIG. 5, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 5, an illustrative operating environment for embodiments of the invention will be described. As shown in FIG. 5, computer 500 comprises a general purpose desktop, laptop, handheld, mobile or other type of computer (computing device) capable of executing one or more application programs. The computer 500 includes at least one central processing unit 508 (“CPU”), a system memory 512, including a random access memory 518 (“RAM”) and a read-only memory (“ROM”) 520, and a system bus 510 that couples the memory to the CPU 508. A basic input/output system containing the basic routines that help to transfer information between elements within the computer, such as during startup, is stored in the ROM 520. The computer 502 further includes a mass storage device 514 for storing an operating system 532, application programs, and other program modules.

The mass storage device 514 is connected to the CPU 508 through a mass storage controller (not shown) connected to the bus 510. The mass storage device 514 and its associated computer-readable media provide non-volatile storage for the computer 500. Although the description of computer-readable media contained herein refers to a mass storage device, such as a hard disk or CD-ROM drive, it should be appreciated by those skilled in the art that computer-readable media can be any available media that can be accessed or utilized by the computer 500.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 500.

According to various embodiments of the invention, the computer 500 may operate in a networked environment using logical connections to remote computers through a network 504, such as a local network, the Internet, etc. for example. The computer 502 may connect to the network 504 through a network interface unit 516 connected to the bus 510. It should be appreciated that the network interface unit 516 may also be utilized to connect to other types of networks and remote computing systems. The computer 500 may also include an input/output controller 522 for receiving and processing input from a number of other devices, including a keyboard, mouse, etc. (not shown). Similarly, an input/output controller 522 may provide output to a display screen, a printer, or other type of output device.

As mentioned briefly above, a number of program modules and data files may be stored in the mass storage device 514 and RAM 518 of the computer 500, including an operating system 532 suitable for controlling the operation of a networked personal computer, such as the WINDOWS® operating systems from MICROSOFT CORPORATION of Redmond, Wash. The mass storage device 514 and RAM 518 may also store one or more program modules. In particular, the mass storage device 514 and the RAM 518 may store application programs, such as a software application 524, for example, a word processing application, a spreadsheet application, a slide presentation application, a database application, etc.

According to embodiments of the present invention, a graphical user interface testing system 100 is illustrated with which a user interface may be tested as described herein. According one embodiment, all components of the system 100 may be operated as an integrated system stored and operated from a single computing device 500. Alternatively, one or more components of the system 100 may be stored and operated at different computing devices 500 that communicate with each other via a distributed computing environment. Software applications 502 are illustrative of software applications having user interfaces that may require testing and analysis by the graphical user interface testing system 100, described herein. Examples of software applications 502 include, but are not limited to, word processing applications, slide presentation applications, spreadsheet applications, desktop publishing applications, and any other application providing one or more user interface components that may require testing and analysis.

It should be appreciated that various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein. Although the invention has been described in connection with various embodiments, those of ordinary skill in the art will understand that many modifications may be made thereto within the scope of the claims that follow. Accordingly, it is not intended that the scope of the invention in any way be limited by the above description, but instead be determined entirely by reference to the claims that follow.

We claim:

1. A method of testing a graphical user interface, comprising:
receiving one or more data items associated with components of the graphical user interface (UI);
transforming the one or more data items into a testing format;
storing the transformed one or more data items to a UI testing database;
at the UI testing database, providing one or more test procedures on the transformed one or more data items; and
providing access to the UI testing database for reviewing one or more results of the one or more test procedures.

2. The method of claim 1, wherein transforming the one or more data items into a testing format includes transforming each of the one or more data items into an Extensible Markup Language (XML) format.

3. The method of claim 2, wherein transforming the one or more data items into a testing format further includes parsing the one or more data items from a UI build data file and tagging each of the one or more data items with an XML tag so that each of the one or more data items may be located and processed based on the XML tag.

4. The method of claim 1, wherein storing the transformed one or more data items to a UI testing database includes storing the transformed one or more data items to a UI testing database associated with a SQL server operative to process the one or more data items against the one or more test procedures.

5. The method of claim 1, wherein providing one or more test procedures on the transformed one or more data items, includes providing one or more test procedures on the one or more data items in response to a call to the UI database for execution of a given test procedure.

6. The method of claim 1, wherein providing one or more test procedures on the transformed one or more data items, includes indexing the one or more data items stored at the UI testing database.

7. The method of claim 6, wherein providing one or more test procedures on the transformed one or more data items, includes enabling a query for a given data item contained in the one or more data items.

8. The method of claim 1, wherein providing one or more test procedures on the transformed one or more data items, includes enabling a build differencing comparison between two separate build data sets for a given user interface component.

9. The method of claim 1, wherein prior to providing access to the UI testing database for reviewing one or more results of the one or more test procedures, further comprising providing a user interface testing application that is operatively associated with the UI testing database for invoking each of the one or more test procedures on the transformed one or more data items.

10. The method of claim 9, wherein providing a user interface testing application that is operatively associated with the UI testing database, further comprises providing a testing application user interface for enabling an invocation of each of the one or more test procedures on the transformed one or more data items and for displaying the one or more results of the one or more test procedures.

11. A computer readable medium containing computer executable instructions which when executed perform a method of testing a graphical user interface, comprising:
transforming one or more data items associated with the graphical user interface into a testing format;
providing one or more test procedures on the transformed one or more data items; and
providing access to one or more results of the one or more test procedures for enabling analysis of the graphical user interface.

12. The computer readable medium of claim 11, wherein transforming one or more data items associated with the graphical user interface into a testing format includes transforming each of the one or more data items into an Extensible Markup Language (XML) format.

13. The computer readable medium of claim 11, wherein transforming the one or more data items into an Extensible Markup Language (XML) testing format further includes parsing the one or more data items from a UI build data file and tagging each of the one or more data items with an XML tag so that each of the one or more data items may be located and processed based on the XML tag.

14. The computer readable medium of claim 11, prior to providing one or more test procedures on the transformed one or more data items, storing the transformed one or more data items to a UI testing database.

15. The computer readable medium of claim 14, wherein storing the transformed one or more data items to a UI testing database includes storing the transformed one or more data items to a UI testing database associated with a SQL server operative to process the one or more data items against the one or more test procedures.

16. The computer readable medium of claim 11, wherein providing one or more test procedures on the transformed one or more data items, includes enabling a query for a given data item contained in the one or more data items.

17. The computer readable medium of claim 11, wherein providing one or more test procedures on the transformed one or more data items, includes enabling a build differencing comparison between a first build data for a given user interface component and a different build data for the given user interface component.

18. The computer readable medium of claim 14, wherein prior to providing access to one or more results of the one or more test procedures for enabling analysis of the graphical user interface, further comprising providing a user interface testing application that is operatively associated with the UI testing database for invoking each of the one or more test procedures on the transformed one or more data items.

19. A system for testing a graphical user interface, comprising:
a user interface parser operative
to receive one or more data items associated with components of the graphical user interface (UI);
to transform the one or more data items into a testing format;
to store the transformed one or more data items to a UI testing database;
the UI testing database operative
to provide one or more test procedures on the transformed one or more data items; and
to allow a review of one or more results of the one or more test procedures.

20. The system of claim 19, further comprising:
a user interface testing application that is operatively associated with the UI testing database for invoking each of the one or more test procedures on the transformed one or more data items, the user interface testing application providing a testing application user interface for enabling an invocation of each of the one or more test procedures on the transformed one or more data items and for displaying the one or more results of the one or more test procedures.
